(19) United States
(12) Patent Application Publication
(10) Pub. No.: US 2015/0370001 A1
(43) Pub. Date: Dec. 24, 2015

(54) BIREFRINGENT POLYARAMIDE COATED LIGHT GUIDE

(71) Applicant: LIGHT POLYMERS B.V., Amsterdam (NL)

(72) Inventors: Evgeny Morozov, Burlingame, CA (US); Sergey Fedotov, Dzerzhinsk (RU); Joseph McConnaughey, Chino, CA (US)

(21) Appl. No.: 14/533,826

(22) Filed: Nov. 5, 2014

Related U.S. Application Data
(60) Provisional application No. 62/016,205, filed on Jun. 24, 2014.

(51) Int. Cl. F21V 8/00; G02B 5/30; G02F 1/1335

(52) U.S. Cl. CPC G02B 6/0056; G02F 1/1336; G02B 5/3016; G02B 6/0035; G02B 6/0065

(57) ABSTRACT

A light guide includes a birefringent polyaramide layer on a major surface of the light guide. The birefringent polyaramide layer has a refractive index greater than 1.55 and a birefringence of at least 0.1.

### RELATED APPLICATION

This application claims the benefit under 35 U.S.C. §119(e) of U.S. Provisional Patent Application No. 62/016,205, filed on Jun. 24, 2014, and titled BIREFRINGENT LIQUID CRYSTAL COATED LIGHT GUIDE, which is hereby incorporated by reference in its entirety.

### BACKGROUND

Demands for thinner, brighter, and more energy efficient displays continue to grow for mobile devices, computers, television sets, and other display devices. An edge-lit backlighting technology for liquid crystal displays allows significant reduction of thickness by positioning light sources at one or more edges of a light guide/optical film stack as compared to direct-lit backlighting in which light sources are positioned behind an optical film stack. However, distributing the light from one or more illuminated edges to the entire display area and redirecting the light away from the major surface of the backlight and towards the viewer in a uniform and efficient manner is challenging. Light guides with light extraction elements are utilized for this purpose.

Typical light guides have used some type of light extraction feature to extract light out of an edge lit light guide. Embossed, etched, or printed dots have been utilized to extract light from a light guide. Due to the total internal reflection (TIR) propagation mechanism, the light exits the light guide with a peak at an angle of around 7 degrees off the plane of the light guide. This light typically must be redirected to the direction of the observer's eyes and collimated.

### SUMMARY

The present disclosure relates to birefringent polyaramide coated light guides. The birefringent polyaramide material can have a refractive index of 1.55 or greater or be in a range from 1.55 to 1.9. This polyaramide material extracts light from the light guide and can form at least a portion of a major surface of the light guide.

In one aspect, a light guide includes a birefringent polyaramide layer coated on a major surface of the light guide. The birefringent polyaramide layer has a refractive index greater than 1.55 and a birefringence of at least 0.1.

In another aspect, a method of forming a light guide includes depositing an aqueous layer onto a surface of a light guide. The aqueous layer includes a birefringent polyaramide. Then the method includes drying the aqueous layer to form a birefringent polymeric layer. The birefringent polymeric layer has a refractive index greater than 1.55, and a birefringence of at least 0.1, and is substantially transparent.

These and various other features and advantages will be apparent from a reading of the following detailed description.

### BRIEF DESCRIPTION OF THE DRAWINGS

The disclosure may be more completely understood in consideration of the following detailed description of various embodiments of the disclosure in connection with the accompanying drawings; in which:

FIG. 1 is an exploded schematic diagram view of an illustrative backlight assembly;

FIG. 2 is schematic diagram side view of an illustrative light guide assembly;

FIG. 3A is a schematic diagram top view of the illustrative light guide assembly of FIG. 2;

FIG. 3B illustrates three plots of an average area density of light extraction elements as a function of distance from a light source edge of the light guide, in accordance with some embodiments;

FIG. 4 is schematic diagram side view of another illustrative light guide assembly;

FIG. 5 is a schematic illustrative flow diagram of a method of forming a light guide;

FIG. 6 is a plot of angular distribution of light extracted from the light guide of Example 1;

FIG. 7 is a plot of radiance of light extracted from the light guide, as a function of distance away from the LEDs according to Example 2; and

FIG. 8 is a plot of radiance of light extracted from the light guide, as a function of distance away from the LEDs according to Example 3.

### DETAILED DESCRIPTION

In the following detailed description, reference is made to the accompanying drawings that form a part hereof, and in which are shown by way of illustration several specific embodiments. It is to be understood that other embodiments are contemplated and may be made without departing from the scope or spirit of the present disclosure. The following detailed description, therefore, is not to be taken in a limiting sense.

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise.

As used in this specification and the appended claims, the term “or” is generally employed in its sense including “and/or” unless the content clearly dictates otherwise.

As used herein, “have”, “having”, “include”, “including”, “comprise”, “comprising” or the like are used in their open ended sense, and generally mean “including, but not limited to”. It will be understood that “consisting essentially of”, “consisting of”, and the like are subsumed in “comprising,” and the like.

In this disclosure:

“thermally stable” refers to materials that remain substantially intact at 100 degrees Celsius;
“birefringent” refers to the optical property of a material having a refractive index that depends on the polarization and/or propagation direction of light be transmitted therethrough;
“water soluble” or “aqueous” refers to a material being soluble or dissolved in water at an amount of at least 1% wt or at least 10% wt of the material in water at 20 degrees Celsius and 1 atmosphere;
“water insoluble” refers to a material being not soluble in water at an amount of at less than 1% wt or less than 0.1% wt of the material in water at 20 degrees Celsius and 1 atmosphere
“refractive index” or “index of refraction,” refers to the absolute refractive index of a material that is understood to be the ratio of the speed of electromagnetic radiation in free space to the speed of the radiation in that material. The refractive index can be measured using known methods and is generally measured using an Abbe refractometer in the visible light region (available commercially, for example, from Fisher Instruments of Pittsburgh, Pa.). It is generally appreciated that the measured index of refraction can vary to some extent depending on the instrument;
“substantially transparent” refers to a material that transmits at least 90%, or at least 95%, or at least 98% of incident visible light excluding reflections at the interfaces (e.g., due to index mismatches) light transmittance values can be measured using ASTM methods and commercially available light transmittance instruments;
“substantially non-scattering” refers to a material that has a haze value of less than 10% or less than 5% or less than 1%, haze values can be measured using ASTM methods and commercially available haze meters from BKY Gardner Inc., USA, for example;
“scattering” refers to a material that has a haze value of greater than 20% or greater than 30% or greater than 40%, or in a range from 20 to 40%.

An edge lit light guide receives light from one or more of its edges and transmits the light away from the edge by total internal reflection at the major surfaces. A conventional light guide can have a number of light extraction features, which are typically rough distinct shapes or groove-type shapes, disposed on one or more of the light guide's major opposing surfaces, such as a top and/or bottom surface that allow redirecting the light towards a viewer. However, conventional light guides have significant light losses due to multiple reflections and scatterings that the light experiences in these guides before exiting the light guide. These light losses are also caused by the design of light sources and interface between the light sources and the light guide. The light losses are typically compensated by using either powerful light sources or additional light sources, both leading to high power consumption.

The present disclosure relates to birefringent polyaramide coated light guides. The birefringent polyaramide material can have a refractive index of 1.55 or greater or be in a range from 1.55 to 1.9. This birefringent polyaramide material is thermally stable and extracts light from the light guide and can form at least a portion of the major surface of the light guide facing the viewer and/or a portion of an opposing back surface of the light guide. The birefringent polyaramide materials can exhibit a liquid crystal phase before the coating or layer is dried. These liquid crystal or polymer polyaramide materials are aqueous or water soluble and can be coated by, for example, spraying or printing onto a major surface or light transmitting surface of a light guide. The birefringent polyaramide layer can form a continuous layer on the light guide surface or the birefringent polyaramide can form a plurality of light extraction features on the light guide surface. The birefringent polyaramide layer can be substantially transparent and may be either substantially non-scattering or scattering. The birefringent polyaramide layer can be stabilized or made water in-soluble by cross-linking or ion exchange of the coated birefringent polyaramide layer. While the present disclosure is not so limited, an appreciation of various aspects of the disclosure will be gained through a discussion of the examples provided below.

In many embodiments the birefringent polyaramide structure is used to extract the light and cause it to exit the light guide at angles closer to perpendicular to the plane of the light guide. In many embodiments (such as when the birefringent polyaramide is sprayed onto the light guide major surface, for example), the birefringent polyaramide has no well-defined domains; instead it has the principal refractive indices continuously varying in orientation from point to point. An absence of abrupt changes of the material's refractive index in the coating or discrete structures (birefringent polyaramide materials) on the light transmitting surface results in deflection of the light rather than scattering of the extracted light.

The birefringent polyaramide coating can be used on either or both major front or back surfaces and with or without additional conventional light extraction features on the light guide. The light extraction features are formed of the birefringent polyaramide material. Possible coating methods include, for example: slot-die, curtain coating, spray-coating, or printing (screen, ink jet or flexographic). Control over deposition parameters and drying process makes it possible to tune features of the polyaramide structure and optimize light extraction from the light guide in regard to, at least, light efficiency and angular characteristics.

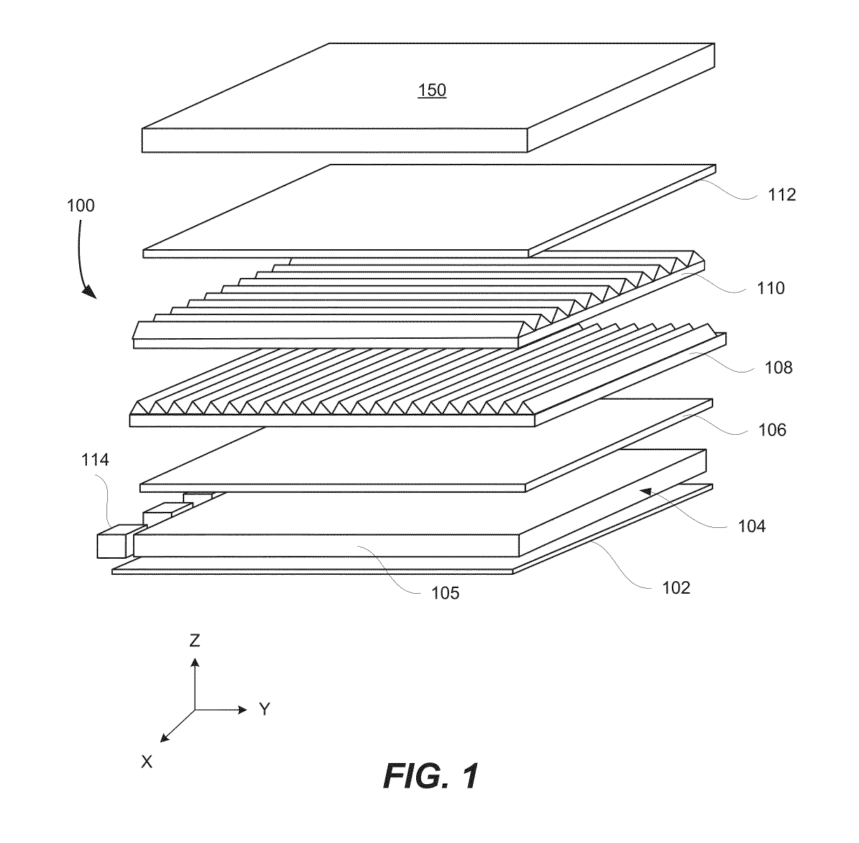

FIG. 1 is an exploded schematic diagram view of an illustrative backlight assembly 100. The backlight assembly 100 may include a reflector 102, a light guide assembly 104, one or more diffusers 106 and 112, and two prisms sheets 108 and 110. In some embodiments, the backlight assembly 100 includes additional components or fewer components than illustrated in FIG. 1. An optional liquid crystal display panel 150 is illustrated and can be adjacent to the backlight assembly 100 for illumination by the backlight assembly 100 and forming a liquid crystal display apparatus.

The light guide assembly 104 can include a one or more light sources 114 disposed along one or more edges of light guide 105. Some examples of light sources include cold cathode fluorescent (CCFL) devices, light emitting diode (LED) devices, lasers or laser diodes. However, other types of light sources may be used as well.

The light guide 105 propagates the light away from light sources 114 (generally along the Y direction). In the illustrative embodiment shown in FIG. 1, light sources 114 are arrayed in the X direction along the edge of light guide 105. In some embodiments further described below, light sources may be arrayed along two or more edges, such as two opposite edges of the light guide 105. Light guide 105 also redirects the light along the Z direction to the viewer and to the reflector. Uniform illumination across the entire major surface display area (defined by the X and Y axes) and luminance sufficient to produce a bright image in an operating environment of the display are two of many considerations in the design of light guide 105. The light extracting features of the light guide extract light through both of the major surfaces. When a reflector is positioned adjacent one of the major surfaces (e.g., the back major surface), the reflector reflects light extracted from the light guide and incident thereon back towards the light guide and through the front major surface. In this way, the light is emitted from the front major surface of the light guide assembly and is available for backlighting an LCD.

A light guide is typically a sheet of poly(methyl methacrylate) (PMMA) having a refractive index about 1.5, or polycarbonate (PC), having an index of refraction of about 1.58, for example. In some embodiments the light guide assembly additionally includes conventional light extraction features. Conventional light extraction features include an array of white dots that can be printed on one side of the light guide to create light scattering to change the direction of the light and allow the light to escape the light guide, for example. Another example of a conventional light extraction feature is a groove-type or other three-dimensional structure, protruding away from the major surface or recessed into the major surface, formed by embossing, extruding, laser etching, or chemical etching

To improve light extraction from the light guide and hence improve light output from in the backlight, the light guide includes a birefringent polyaramide layer or distinct features coated on a major surface of the light guide. The birefringent polyaramide layer has a refractive index value that is greater than 1.55 or greater than 1.6, or greater than 1.65, or greater than 1.7 and a birefringence value of at least 0.1, or at least 0.2 or at least 0.25. The birefringent polyaramide layer is formed from a water-soluble or aqueous polyaramide material (that can be stabilized or rendered water-insoluble upon further processing of the coated birefringent polyaramide layer.) This birefringent polyaramide layer extracts light from the light guide and forms at least a portion of a major surface of the light guide. In many embodiments, the birefringent polyaramide material forms extraction features and at least a portion of the major surface of the light guide facing the viewer. In some of these embodiments, additional conventional light extraction features are on the opposing back major surface of the light guide. In other embodiments, the birefringent polyaramide material forms extraction features and at least a portion of the back major surface of the light guide. In some of these embodiments, additional birefringent polyaramide material also forms extraction features and at least a portion of the major surface of the light guide facing the viewer.

In many embodiments, the birefringent polyaramide layer is substantially transparent and substantially non-scattering. In other embodiments, the birefringent polyaramide layer and/or distinct features is/are is substantially transparent and substantially scattering. The birefringent polyaramide layer and/or distinct features has/have a thickness of less than 5 micrometers, or less than 2.5 micrometers, or less than or equal to one micrometer or in a range from 250 to 1500 nanometers or in a range from 500 to 1000 nanometers.

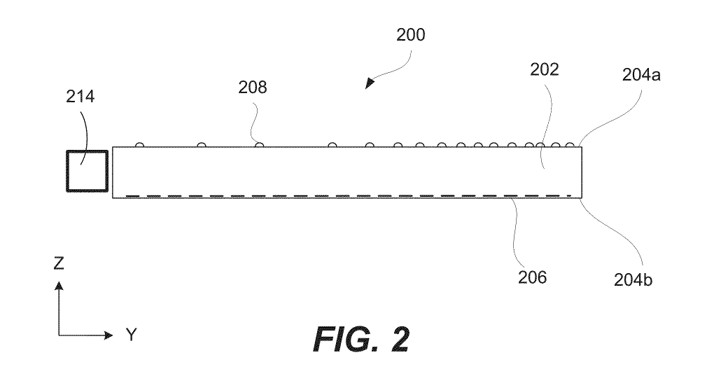

FIG. 2 is schematic diagram side view of an illustrative light guide assembly 200 which includes a light guide 202 and a light source 214 emitting light into an edge of the light guide 202. The light guide 202 includes a plurality of discrete light extraction features 208 (birefringent polyaramide material) on the major surface of the light guide facing the viewer 204a (major surface facing a viewer or LCD panel). Light guide assembly 200 includes a light guide 202 having a front major surface 204a and an opposing back major surface 204b. Front major surface 204a faces a viewer, while back major surface 204b is an opposite surface of light guide assembly 200. The Z axis defines a viewing direction normal to the front major surface 204a. Any light extracted from light guide assembly 200 will have at least some Z-axis component. In many embodiments, back major surface 204b includes extraction features 206 disposed on the back surface 204b.

The back surface extraction features 206 can be a continuous layer or discrete light extraction features of birefringent polyaramide material (described herein) or conventional extraction features such as reflective dots (white dots) or structures embedded into or extending away from the back surface 204b. In some embodiments, the plurality of discrete light extraction features 206 (birefringent polyaramide material) are disposed only on the planar back surface 204b (not shown). In further embodiments, the plurality of discrete light extraction features 206, 208 (birefringent polyaramide material) are disposed on both the planar front surface 204a and the planar back surface 204b.

The discrete light extraction features 208 (birefringent polyaramide material) have a thickness or height that extends away from the front surface 204a of less than 2.5 micrometers, or less than 2 micrometers, or less than 1.5 micrometers, or less than 1 micrometer, or in a range from 100 to 2000 nanometers, or in a range from 250 to 1500 nanometers, or in a range from 500 to 1000 nanometers. The discrete light extraction features 208 (birefringent polyaramide material) can have a lateral dimension (dimension along the X and Y directions) of 200 micrometers or less, or 100 micrometers or less, or from 10 to 100 micrometers.

Light guide 202 may be made from PMMA, PC, cyclic olefin copolymers (COC), cyclic olefin polymers (COP), and other suitable materials. Light guide 202 may be formed using molding, extrusion, or casting. The thickness of a light guide may be between about 0.2 millimeters and 3 millimeters. The light guide thickness is primarily determined by the geometry (e.g., size) of the light sources. In some embodiments, the light guide may have a tapered thickness profile. Specifically, the light guide is thicker at the light source edge and thinner at the opposite edge. In certain embodiments, the birefringent polyaramide layer is a multilayered structure and may include a primer layer applied onto the light guide prior to applying birefringent polyaramide material.

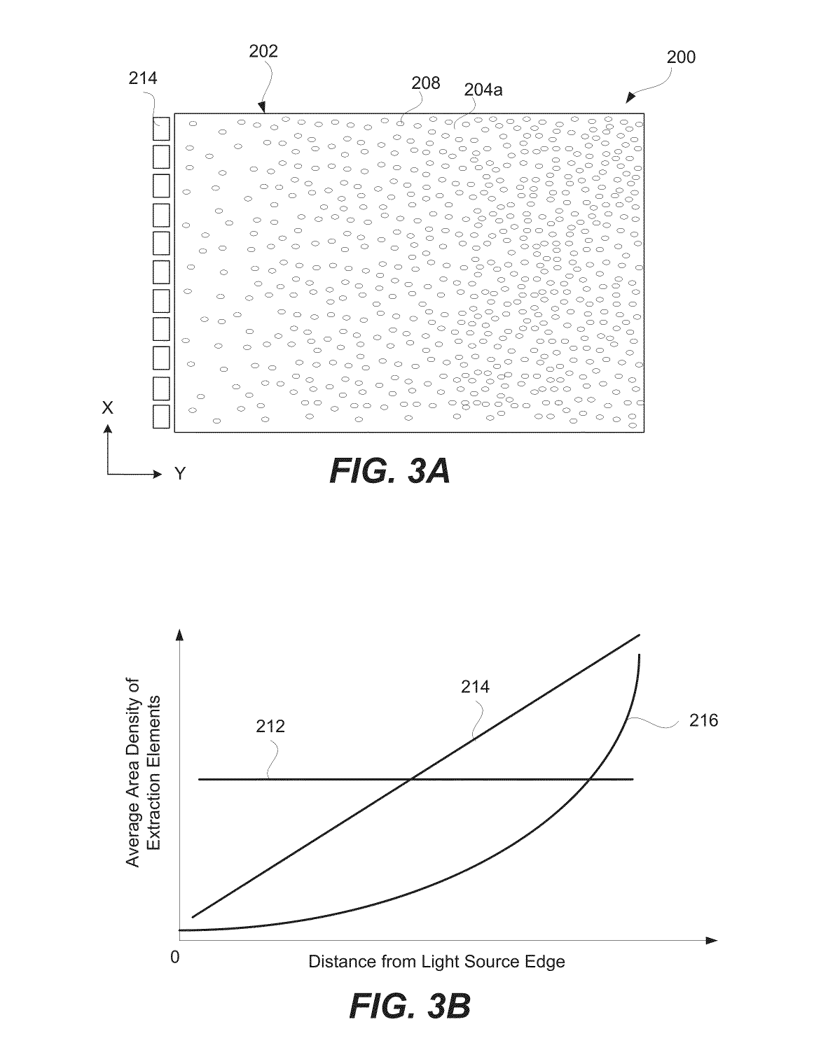

FIG. 3A is a schematic diagram top view of the illustrative light guide assembly 200 of FIG. 2. FIG. 3B illustrates three plots of an average area density of light extraction elements 208 as a function of distance from a light source edge of the light guide, in accordance with some embodiments.

Light guide assembly 200 is shown with a set of light sources 214 disposed along one edge of light guide 202. An exemplary distribution of light extracting features 208 on the light guide 202 is illustrated. In this embodiment, light guide 202 transmits the light emitted by light sources 214 with a component in the Y direction and away from light sources 214. Light guide assembly 200 is also configured to extract the light away from light guide 202 and towards the viewer. When light source 214 light approaches discrete light extracting features 208 at certain angles and/or at certain locations (e.g., due to the curvature of light extracting features 208), the light ray no longer satisfies TIR conditions and is extracted from light guide 202. Light extracting features 208, 206 can be configured (on either or both of the front surface 204a and/or back surface 204b) to provide substantially uniform light extraction throughout the entire display. In some embodiments, uniformity corresponds to any two equally-sized areas of the display having a total light energy substantially the same, in conformance with display manufacturing standards.

Light intensity within light guide 202 decreases in the Y direction away from light sources 214. In order to achieve uniform light extraction from light guide 202, light extraction features 208 have one or more characteristics that change in the Y direction. Examples of these changing characteristics include area density, size, and shape of light extracting features 208.

FIG. 3A illustrates light extracting features 208 that have non-uniform density. Specifically, density of light extracting features 208 increases along the Y direction away from light sources 214. A higher density of light extracting features 208 enables extracting a greater fraction of the remaining light from light guide 202. Since the light intensity decreases along the Y direction, the increase in density of light extracting features 208 compensate for this decrease and ensures uniform light extraction.

FIG. 3B illustrates three plots of an average light extracting feature area density as a function of distance from a light source edge of the light guide, in accordance with some embodiments. Plot 212 corresponds to a uniform density along the entire length of the light guide. In this example, uniform light extraction may be achieved by other techniques, such as variable size and/or shapes of the light extracting features. Plot 214 corresponds to a linear increase in density of light extracting features along the length of the light guide. This approach may be taken, for example, when the light intensity within the light guide decreases in a linear fashion. Finally, plot 216 corresponds to a non-linear (e.g., super linear) increase in density of light extracting features throughout the length of the light guide. This approach may be taken, for example, when the light intensity within the light guide decreases in a non-linear fashion.

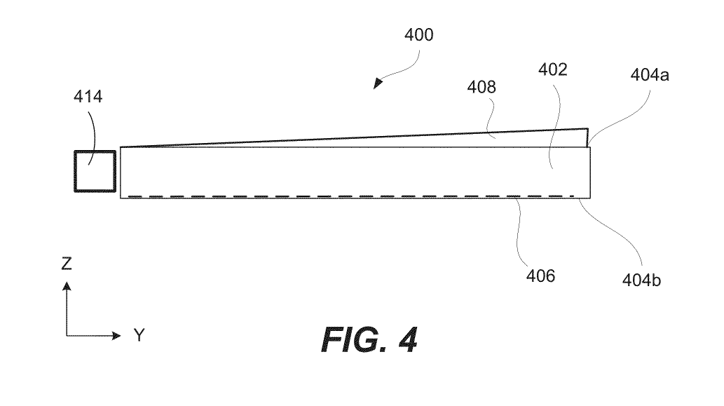

FIG. 4 is schematic diagram side view of another illustrative light guide assembly 400 having a continuous light extraction coating 408 (birefringent polyaramide material) on the planar front surface 404a. The continuous light extraction coating 408 can have a wedge cross-sectional shape as illustrated where the birefringent polyaramide layer has a thickness that increases as a function of a distance from a light source 414 emitting light into the light guide 400. Light guide assembly 400 includes a light guide 402 having a front major surface 404a and an opposing back major surface 404b. Front major surface 404a faces a viewer, while back major surface 404b is an opposite major surface of light guide 402. The Z axis direction is normal to the major surfaces. Any light extracted from the light guide assembly 400 will have at least some Z-axis component. In many embodiments, back surface extraction features 406 are disposed on or in the back surface 404b. The back surface extraction features 406 can be a continuous layer or discrete light extraction features of birefringent polyaramide material (described herein) or conventional extraction features such as reflective dots (white dots) or structures recessed into or protruding away from the back surface 404b.

In some embodiments, the continuous light extraction coating 408 (birefringent polyaramide material) is disposed only on the planar back surface 404b (not shown). In other embodiments, the continuous light extraction coating 408 (birefringent polyaramide material) is disposed on both the planar front surface 404a and the planar back surface 404b (not shown).

In many embodiments the continuous light extraction coating 408 is thin (for example, 50 nm, but possibly down to zero), next to or proximate the light source edge of the light guide 402, and gets progressively thicker with the distance from the light source (for example, to a thickness of 500 nm to 1000 nanometers). This wedge shape enables extraction of a larger fraction of the remaining light to compensate for the brightness decrease as the light propagates through the light guide to provide uniform light emission or illumination along the light guide

Light guide 402 can be formed and made from PMMA, PC, cyclic olefin copolymers (COC), cyclic olefin polymers (COP), and other suitable materials, as described above. The thickness of a light guide may be between about 0.2 millimeters and 3 millimeters. The light guide thickness is primarily determined by the geometry (e.g., size) of the light sources. In some embodiments, the light guide may have a tapered thickness profile. Specifically, the light guide is thicker at the light sources edge and thinner at the opposite edge. In certain embodiments, the birefringent polyaramide layer is a multilayered structure and may include a primer layer applied on the light guide prior to applying birefringent polyaramide material.

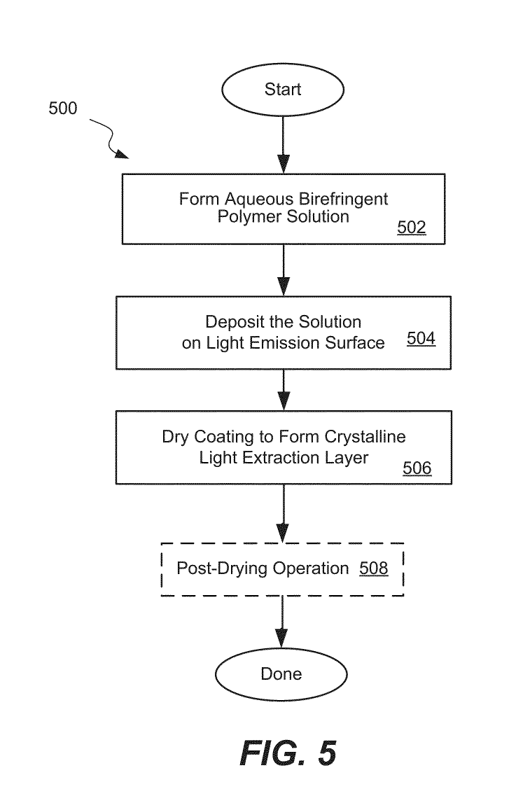

FIG. 5 is a schematic illustrative flow diagram 500 of a method of forming a light guide. The method includes a forming step at 502 where birefringent polyaramide material is mixed with water to form an aqueous birefringent polymer solution. In some embodiments the birefringent polyaramide solution exhibits a lyotropic liquid crystal phase. The birefringent polyaramide solution is at least 75% wt, or at least 80% wt, or at least 85% wt, or at least 90% wt water. In many embodiments the birefringent polyaramide solution is from 1 to 25% wt, or from 1 to 20% wt, or from 1 to 15% wt, or from 1 to 10% wt birefringent polyaramide material.

Then the method includes depositing at 504 the birefringent polymer solution onto a major surface of a light guide to form a layer or discrete feature. Possible coating methods include, for example: slot-die, curtain coating, spray-coating, or printing (screen or ink jet). Control over deposition parameters and drying process makes it possible to tune features of the polyaramide structure and optimize light extraction from the light guide in regard to, at least, light efficiency and angular characteristics. This layer can then be dried at 506 to form a birefringent polyaramide layer. The birefringent polyaramide layer has a refractive index greater than 1.55 and a birefringence of at least 0.1 and is substantially transparent. In many embodiments, the birefringent polyaramide layer or structure is used to extract the light and cause it to exit the light guide in an angle nearer to the normal to the plane of the light guide.

Birefringence described herein refers to macroscopic birefringence or molecular level birefringence. For example, coating the polyaramides (described herein) by any type of shear coating can align the molecules in more or less the same direction over a macroscopic dimension and exhibit a macroscopic birefringence. In other embodiments, the polyaramides (described herein) are printed or sprayed onto the light guide (forming discrete small dots, for example) the molecules may not align in same direction over a macroscopic dimension or exhibit a macroscopic birefringence, however the molecules exhibit birefringence on a molecular level, since these polyaramides themselves are birefringent. In these embodiments the birefringent polyaramide may not form well-defined domains; instead it has the principal refractive indices continuously varying in orientation from point to point.

Birefringence can be characterized by measuring a refractive index of the three principal refractive indices (nₓ, n_{y} and n_{z}) associated with the Cartesian coordinate system related to the deposited birefringent polyaramide layer or the corresponding major surface of the light guide. Two principal directions for refractive indices nₓ and n_{y} may belong to the xy-plane coinciding with a plane of the birefringent polyaramide layer, while one principal direction for refractive index (n_{z}) coincides with a normal line to the birefringent polyaramide layer or major surface of the light guide. This coordinate system is illustrated in FIG. 1. At least two refractive indices among nₓ, n_{y} and n_{z} have different values.

The birefringent polyaramide layer can then have a post-drying operation 508 preformed on it to stabilize or further process the birefringent polyaramide layer. For example, the birefringent polyaramide layer can be stabilized or rendered insoluble in water by “passivating” or by ion exchange or cross-linking the birefringent polyaramide layer.

### Birefringent Polyaramides

The birefringent polymer may be made from various base materials having suitable optical and other properties, such as thermal resistance, light transmittance, and the like. The base material can be water-soluble polyaramides. Water-soluble polyaramide base material can be deposited, or coated onto the light guide via an aqueous solution. Once coated or deposited this polyaramide base material can be stabilized by cross-linking, or made less water soluble by “passivation.” Water-soluble polyaramides can be polymers, partially conjugated substantially planar polycyclic molecular systems, and/or liquid crystals.

In many embodiments, the birefringent polyaramide material described herein can be referred to as a “lyotropic liquid crystal” material since it can exhibit a liquid crystal phase in water. A liquid crystalline material is called lyotropic′ if phases having long-ranged orientational order are induced by the addition of a solvent, such as water. The term can be used to describe materials composed of amphiphilic molecules. Such molecules include a water-loving ‘hydrophilic’ head-group (which may be ionic or non-ionic) attached to a water-hating ‘hydrophobic’ group.

An exemplary birefringent polyaramide that can exhibit a lyotropic liquid crystal phase includes the following formula:

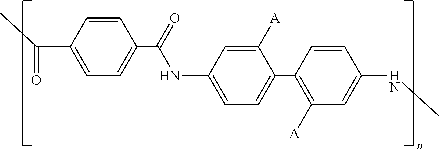

wherein;
A is independently selected from SO₃H or COOH, or their salt of an alkali metal, ammonium, quaternary ammonium, alkali earth metal, Al³⁺, La³⁺, Fe³⁺, Cr³⁺, Mn²⁺, Cu²⁺, Zn²⁺, Pb²⁺ or Sn²; and n is an integer from 2 to 10,000. In one embodiment, the number-average molecular weight is about 10,000 to about 150,000. In another embodiment, the number-average molecular weight is about 50,000 to about 150,000.

Examples of synthesis of this polymer are described in U.S. Pat. No. 8,512,824. In many embodiments the birefringent polyaramide is a polymer of a formula below:

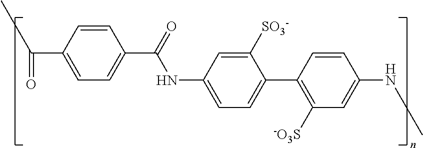

wherein n is an integer in a range from 2 to 10,000 or from 5 to 2000. In one embodiment, the number-average molecular weight is about 10,000 to about 150,000. In another embodiment, the number-average molecular weight is about 50,000 to about 150,000. This can be referred to as: poly(2,2′-disulfo-4,4′-benzidine terephthalamide) and can be a sodium or ammonium salt thereof. An example of a synthesis of this polymer is described in U.S. Pat. No. 8,512,824. A birefringent polyaramide film or layer formed from this polymer is birefringent and has the following refractive indices: nₓ=1.84, n_{y}=n_{z}=1.58, where nₓ and n_{y} correspond to two mutually perpendicular directions in a plane and n_{z} corresponds to the normal direction to the plane. This birefringent polyaramide can form a light extracting feature that is substantially transparent and scattering or having a haze value in a range from 20 to 40%.

Another exemplary birefringent polyaramide is a copolymer that includes a segment including the following general formula:

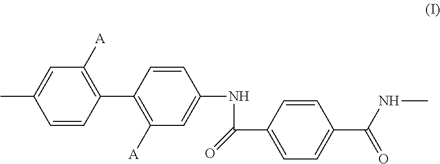

and a segment including the following general formula:

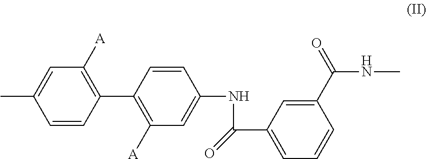

where A is independently selected from SO₃H or COOH, or their salt of an alkali metal, ammonium, quaternary ammonium, alkali earth metal, Al³⁺, La³⁺, Fe³⁺, Cr³⁺, Mn²⁺, Cu Zn²⁺, Pb²⁺ or Sn²⁺; and wherein at least one segment of formula (I) and one segment of formula (II) are connected by a covalent bond. The polymer segment may include a single segment of formula (I) bonded to a single segment of formula (II), or mixed segments of formula (I) and formula (II). This copolymer can have a number-average molecular weight in a range from 2,000 to 50,000.

For example, in one embodiment the polymer segments include a segment including the following formula:

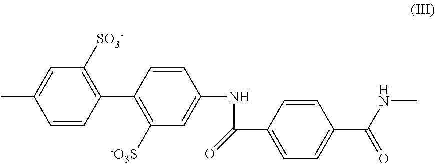

and a segment including the following formula:

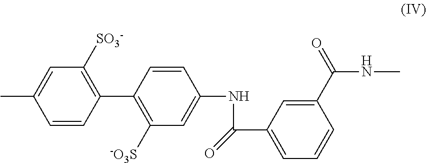

where at least one segment of formula (III) and one segment of formula (IV) are connected by a covalent bond. This copolymer can have a number-average molecular weight in a range from 2,000 to 50,000.

In one embodiment, the birefringent polyaramide layer includes a random copolymer that having the following formula:

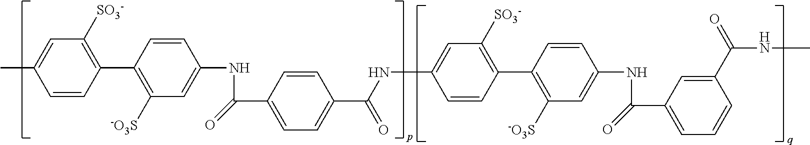

p and q are integers greater than zero and p+q is an integer greater than 5 or greater than 10. In one embodiment, the ratio of segments p to segments of formula q is about 73:27. In other embodiments, the ratio of segments can be 1:99, 5:95, 10:90, 15:85, 20:80, 25:75, 30:70, 35:65, 40:60, 45:55, 50:50, 55:45, 60:40, 65:35, 70:30, 75:25, 80:20, 85:15, 90:10, 95:5, 99:1, or any ratio in between or range of these ratios. In some embodiments, the number-average molecular weight can be between 2,000 and 50,000, between 2,000, and 10,000, or between 4,000 and 6,000, and the number-average molecular weight is about 5000.

Examples of synthesis of a copolymer including these segments are described in U.S. Publication No. 2010/0190015. This can be referred to as: 2,2′-disulfo-4,4′-benzidine terephthalamide-isophthalamide copolymer and can be a sodium or ammonium salt thereof. A birefringent polyaramide film or layer formed from this random copolymer is birefringent and has the following refractive indices: nₓ=n_{y}=1.7 and n_{z}=1.5, where nₓ and n_{y} correspond to two mutually perpendicular directions in a plane and n_{z} corresponds to the normal direction to the plane. In one embodiment, the ratio of segments of formula (III) to segments of formula (IV) is about 27:73 and the number-average molecular weight is about 5000. This birefringent polyaramide can form a light extracting feature that is substantially transparent and substantially non-scattering or having a haze value of 10% or less or 5% or less or 1% or less.

In many embodiments, the birefringent polyaramide layer has a birefringence of at least 0.1, or at least 0.2, or at least 0.25.

Objects and advantages of this disclosure are further illustrated by the following examples, but the particular materials and amounts thereof recited in these examples, as well as other conditions and details, should not be construed to unduly limit this disclosure.

### EXAMPLES

### Example 1

### Wedge Type Coating

A commercial PMMA light guide (6″ wide) with printed light extraction dots was cleaned with IPA and corona treated. The smooth surface of the light guide was primed to improve adhesion of the birefringent polyaramide coating poly(2,2′-disulfo-4,4′-benzidine terephthalamide) as described in U.S. Pat. No. 8,512,824. Priming was done by spraying of the PR01 primer, commercially available from Mica. Target thickness of the primer layer was 10 nm.

Then this birefringent polyaramide material (at 5-15% wt in water) was sprayed on top of the primer. One sample comprised a wedge-shaped layer 50 nm thick near the light source and 500 nm on another end (Coated #1). The second sample had increased the wedge of 100 nm thick near the light source and 2000 nm on the opposing end (Coated #2). Both samples were treated with a 10% water solution of SrCl₂, rinsed with DI water and dried at ambient conditions.

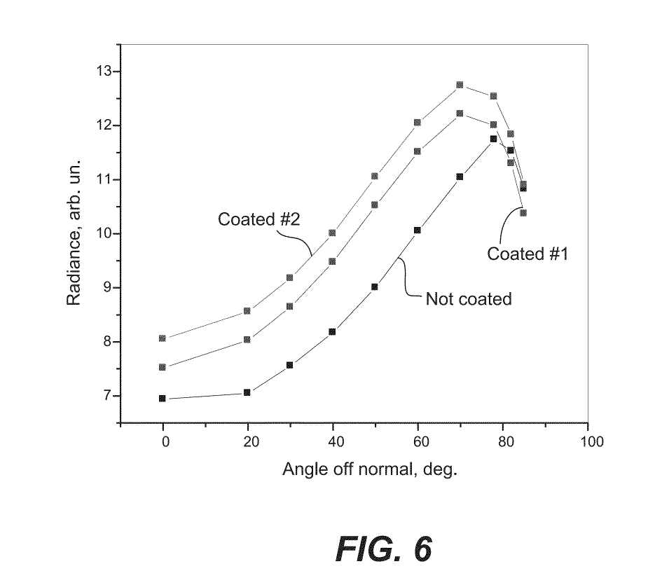

The light guide was illuminated with a 6″ LED bar and measured with a white reflector on its back side. Data was taken from the point 3″ away from the light source for both coated examples and a control non-coated light guide. Results are shown in the radiance graph of FIG. 6 which is a plot of angular distribution of light extracted from the light guide. FIG. 6 illustrates that the birefringent polyaramide light extraction layer causes the extracted light to exit the light guide in an angle nearer to perpendicular to the plane of the light guide.

### Example 2

### Spray Coating

A commercial PMMA light guide (5″ wide) with printed light extraction dots was pretreated as explained in Example 1. The birefringent polyaramide aqueous solution poly(2,2′-disulfo-4,4′-benzidine terephthalamide) described above (7% wt solid content) was spray coated onto the primed PMMA to form discrete randomly distributed printed dots of birefringent polyaramide material having an average lateral size of about 100 micrometers and an average thickness of 0.5 micrometer.

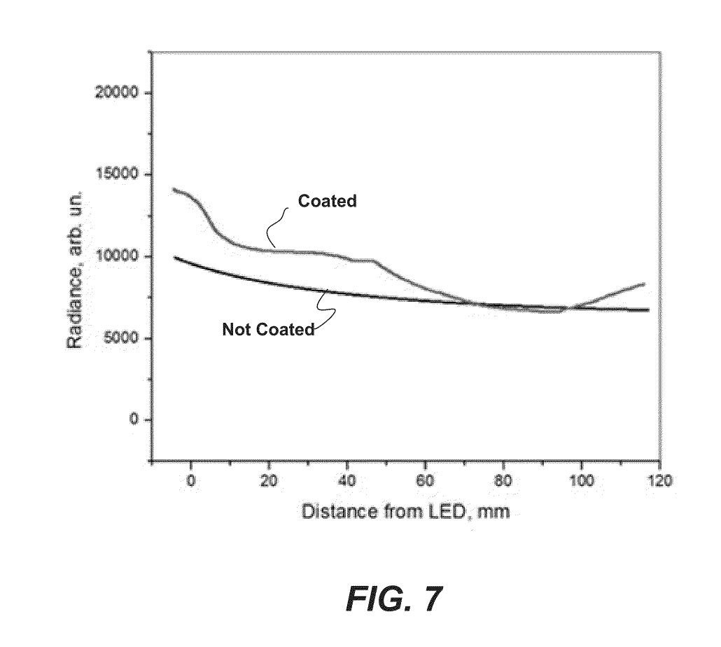

This sprayed light guide was incorporated into the backlight stack comprising reflector, light guide, coarse diffuser, fine diffuser, two BEFs as illustrated in FIG. 1. Light output was measured as a function of the distance from LED bar and reported in FIG. 7. The assembly was mounted on the XY rotation table in such a way that the LED bar was at the bottom. Radiance data was taken with the use of SpectraScan730 spectroradiometer. Angular dependences were measured by rotation of the assembly around its vertical axis. The optical scheme was adjusted in such a way to ensure that the point under measurement (3″ away from the LED bar, in the center) would not move. Measurement of spatial uniformity was carried out in the center of the assembly by translating it in a vertical direction.

FIG. 7 is a plot of radiance of light, as a function of distance from the LEDs, extracted from the printed discrete dot coated light guide and from the not-coated light guide. The average optical gain for the coated light guide was about 10% compared to the uncoated light guide.

### Example 3

### Screen Printing

A commercial PMMA light guide (5″ wide) with printed light extraction dots was pretreated as explained in the Example 1. The birefringent polyaramide aqueous solution poly(2,2′-disulfo-4,4′-benzidine terephthalamide) described above (12.5% wt solid content) was screen printed onto the primed PMMA using an ATMA AT-70PD screen printer (commercially available from ATMA Corp.) to form discrete printed dots of birefringent polyaramide material having a uniform pattern of printed dots having an average lateral size of about 50 micrometers and an average pitch of about 50 and an average thickness of 0.5 micrometer.

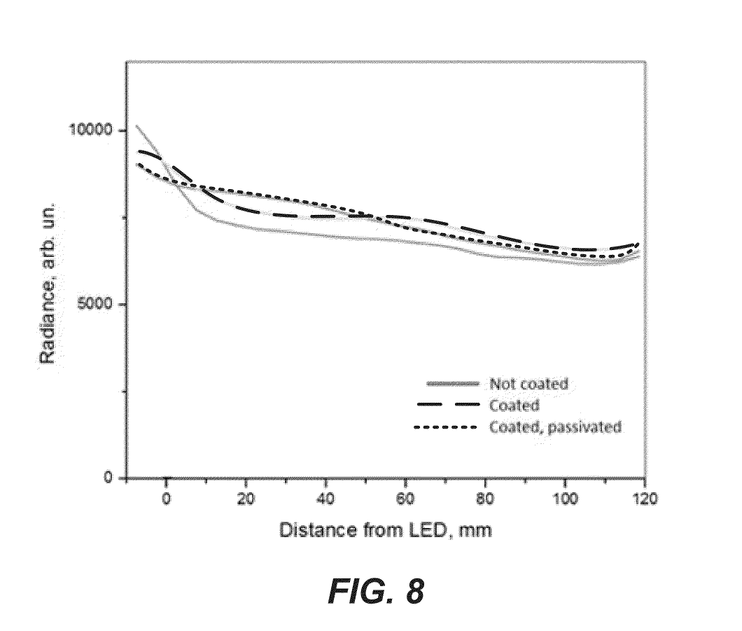

This sprayed light guide was incorporated into the backlight stack comprising reflector, light guide, coarse diffuser, fine diffuser, two BEFs as illustrated in FIG. 1. Light output was measured as a function of the distance from the LED bar and reported in FIG. 8. The assembly was mounted on the XY rotation table in such a way that LED bar was at the bottom. Radiance data was taken with the use of SpectraScan730 spectroradiometer. Angular dependences were measured by rotation of the assembly around its vertical axis. The optical scheme was adjusted in such a way to ensure that the point under measurement (3″ away from the LED bar, in the center) would not move. Measurement of spatial uniformity was carried out in the center of the assembly by translating it in a vertical direction.

FIG. 8 is a plot of radiance of light, as a function of distance from the LEDs, extracted from the screen printed discrete dot coated light guide, a coated and passivated (treated with 10% SrCl₂ and rinsed with DI water) light guide and for the not coated (un-coated) light guide. The average optical gain for the coated light guides (regardless of passivation) was about 4% compared to the uncoated light guide.

Thus, embodiments of BIREFRINGENT POLYARAMIDE COATED LIGHT GUIDE are disclosed.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof. The disclosed embodiments are presented for purposes of illustration and not limitation.

1. A light guide comprising:
a light transmissive substrate comprising a major surface;
a birefringent polyaramide layer coated on the major surface of the light transmissive substrate;
wherein the birefringent polyaramide layer comprises a polyaramide and has a refractive index greater than 1.55 and a birefringence of at least 0.1 and the birefringent polyaramide layer has principal refractive indices that vary in orientation along the major surface.

2. The light guide according to claim 1, wherein the birefringent polyaramide layer is formed from a water-soluble or aqueous polyaramide material.

3. A light guide assembly comprising the light guide according to claim 1, and a light source configured to emit light into an edge surface of the light guide.

4. The light guide assembly according to claim 3, wherein the birefringent polyaramide layer has a thickness that increases as a function of a distance from the light source emitting light into the light guide.

5. The light guide according to claim 1, wherein the birefringent polyaramide layer has a thickness in a range from 500 to 1000 nanometers.

6. The light guide according to claim 1, wherein the birefringent polyaramide layer defines discrete light extraction structures.

7. The light guide assembly according to claim 3, wherein the birefringent polyaramide layer defines discrete light extraction structures and the discrete light extraction structures have an area density that increases as a function of a distance from the light source.

8. The light guide according to claim 1, wherein the birefringent polyaramide layer is substantially transparent and forms at least a portion of the light emitting surface of the light guide.

9. The light guide according to claim 1, wherein the birefringent polyaramide layer is formed from lyotropic liquid crystal polymer of a formula: 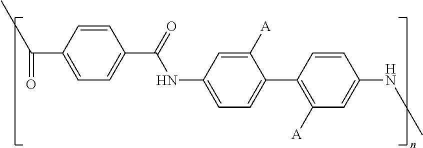
wherein;
A is independently selected from SO₃H or COOH, or their salt of an alkali metal, ammonium, quaternary ammonium, alkali earth metal, Al³⁺, La³⁺, Fe³⁺, Cr³⁺, Mn²⁺, Cu²⁺, Zn²⁺, Pb²⁺ or Sn²⁺; and
n is an integer from 2 to 10,000.

10. The light guide according to claim 9, wherein the birefringent polyaramide layer is formed from lyotropic liquid crystal polymer of a formula: 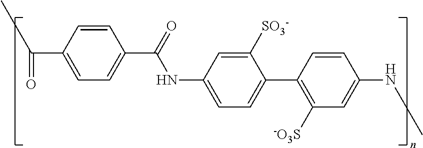
wherein n is an integer in a range from 5 to 2000.

11. The light guide according to claim 1, wherein the birefringent polyaramide layer comprises a copolymer that includes a segment including the following formula: 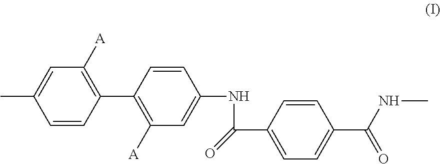
and a segment including the following formula: 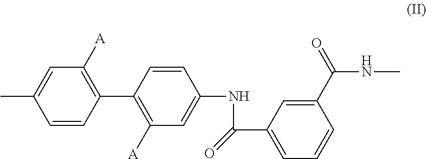
wherein
A is each independently selected from SO₃H or COOH, or their salt of an alkali metal, ammonium, quaternary ammonium, alkali earth metal, Al³⁺, La³⁺, Fe³⁺, Cr³⁺, Mn²⁺, Cu²⁺, Zn²⁺, Pb²⁺ or Sn²⁺; and the copolymer has a number-average molecular weight in a range from 2,000 to 50,000.

12. The light guide according to claim 10, wherein the birefringent polyaramide layer comprises a copolymer that includes a segment including the following general formula: 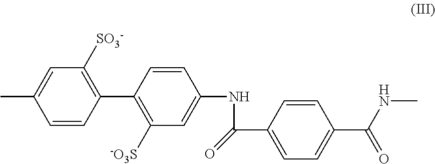
and a segment including the following formula: 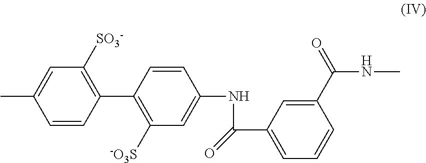
wherein the copolymer has a number-average molecular weight in a range from 2,000 to 50,000.

13. A backlight assembly comprising the light guide according to claim 1, wherein the light guide is edge lit.

14. A liquid crystal display comprising the backlight assembly of claim 13.

15. A lighting assembly comprising the light guide according to claim 3.

16. A method of forming a light guide comprising:
depositing an aqueous layer onto a major surface of a light guide, the aqueous layer comprising a birefringent polyaramide;
drying the aqueous layer to form a birefringent polymeric layer, the birefringent polymeric layer having a refractive index greater than 1.55 and a birefringence of at least 0.1 and is substantially transparent.

17. The method according to claim 16, wherein the birefringent polymeric layer has a wedge shaped cross-section that increases in thickness as a function of a distance from a light input edge through which light from a light source is transmitted.

18. The method according to claim 16, wherein the depositing step comprises printing discrete light extraction features onto a major surface of the light guide.

19. The method according to claim 16, wherein the depositing step comprises spraying the birefringent polyaramide onto a major surface of the light guide.

20. The method according to claim 16, wherein the aqueous layer comprises at least 80% wt water.

21. The method according to claim 16, wherein the birefringent polyaramide layer has a thickness of less than 2.5 micrometers.

22. The method according to claim 16 wherein the birefringent polyaramide layer comprises lyotropic liquid crystal polymer of a formula: 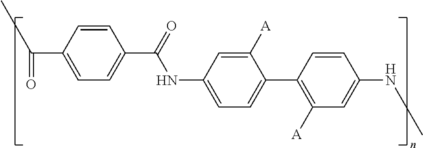
wherein;
A is independently selected from SO₃H or COOH, or their salt of an alkali metal, ammonium, quaternary ammonium, alkali earth metal, Al³⁺, La³⁺, Fe³⁺, Cr³⁺, Mn²⁺, Cu²⁺, Zn²⁺, Pb²⁺ or Sn²⁺; and
n is an integer from 2 to 10,000.

23. The method according to claim 16 wherein the birefringent polyaramide layer comprises a copolymer that includes a segment including the following formula: 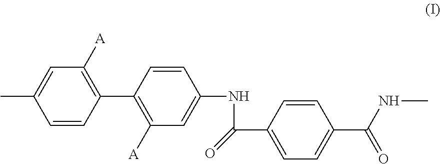
and a segment including the following formula: 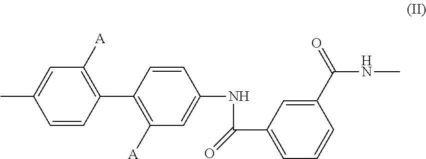
wherein
A is each independently selected from SO₃H or COOH, or their salt of an alkali metal, ammonium, quaternary ammonium, alkali earth metal, Al³⁺, La³⁺, Fe³⁺, Cr³⁺, Mn²⁺, Cu²⁺, Zn²⁺, Pb²⁺ or Sn²⁺; and the copolymer has a number-average molecular weight in a range from 2,000 to 50,000.
